(19) United States
(12) Patent Application Publication
(10) Pub. No.: US 2012/0215637 A1
(43) Pub. Date: Aug. 23, 2012

(54) SYSTEM AND METHOD FOR PERFORMING SOCIAL NETWORKING AND LOYALTY PROGRAM FUNCTIONS AT A VENUE

(76) Inventor: Mark E. Hermann, Wellesley, MA (US)

(21) Appl. No.: 13/353,647

(22) Filed: Jan. 19, 2012

Related U.S. Application Data
(63) Continuation-in-part of application No. 13/231,439, filed on Sep. 13, 2011.
(60) Provisional application No. 61/434,056, filed on Jan. 19, 2011.
(60) Provisional application No. 61/382,216, filed on Sep. 13, 2010.

(51) Int. Cl. G06Q 30/02

(52) U.S. Cl. 705/14.53; 705/14.58; 705/14.27; 705/14.1

(57) ABSTRACT

A method and system is provided that permits a user at a venue location to be more effectively engaged by a venue operator. In one example, a user may be permitted to receive awards based on one or more actions performed by the user at a venue location. Other features such as communications using social networks, games, promotions, among others may be provided to enhance the user's experience at the venue.

### RELATED APPLICATIONS

This application claims priority under 35 U.S.C.§119(e) to U.S. Provisional Application No. 61/434,056 entitled “SYSTEM AND METHOD FOR SOCIAL NETWORKING AT A VENUE,” filed on Jan. 19, 2011, the contents of which is incorporated by reference herein in its entirety. This application is also a continuation-in-part of U.S. application Ser. No. 13/231,439, entitled “APPARATUS AND METHOD FOR SUPPORTING APPLICATIONS IN A DISTRIBUTED NETWORK,” filed on Sep. 13, 2011, which claims priority under 35 U.S.C.§119(e) to U.S. Provisional Application No. 61/382,216 entitled “APPARATUS AND METHOD FOR SUPPORTING LOCATION-BASED MOBILE GAMES”, filed on Sep. 13, 2010, the contents of which applications are incorporated by reference herein in their entirety.

### APPLICABLE FIELD

The applicable field relates to social networking and interactive promotions, and more particularly, to systems and methods for enabling communications, interactive promotions, location-based services, loyalty programs and commerce at a venue such as a theater or stadium.

### BACKGROUND

Attending sports and entertainment venues has become increasingly popular. The growth in the popularity of sport and entertainment attendance has created a windfall for a myriad of sporting and entertainment stakeholders including but not limited to event promoters, and manufacturers of related products, team owners and artists.

Globally, $96 billion a year is spent on the purchase of tickets to sporting and entertainment events. In the United States, for example, teams in some of the major leagues such as the National Football League (NFL), Major League Baseball (MLB) and the National Hockey League (NHL) depend on gate receipts as their largest source of revenue.

To maximize their revenue sources, more venues are upgrading their ticketing and access control products and services, with virtually every vendor offering new technologies to keep pace with both venue and fan demand. At the same time, security concerns such as counterfeit tickets, entrance turnstiles and interior locks are also garnering similar attention.

The sport and entertainment industry marketers recognize the importance of a strong fan base and participation in order to maintain or increase their revenues. To form their marketing strategies, sport and entertainment marketing executives need to understand what motivates people to attend, watch or participate in a sporting event or show, to what teams and entertainer's fans are loyal, and how this loyalty plays out in goods and services purchasing.

Since their introduction, social networks such as MySpace and Facebook have attracted hundreds of millions of users, many of whom have integrated these sites into their daily routines. There are hundreds of social networks, with various technological affordances, supporting a wide range of interests and practices. While their key technological features are fairly consistent, the cultures that emerge around social network sites are varied. Most sites support the maintenance of pre-existing social networks, but others help strangers connect based on shared interests, political views, or activities. Some sites cater to diverse audiences, while others attract people based on common language or shared racial, sexual, religious, or nationality-based identities. Sites also vary in the extent to which they incorporate new information and communication tools, such as mobile connectivity, blogging, micro-blogging, and photo/video-sharing.

Fans tend to identify themselves with the teams/athletes or with entertainers they cheer for and consider themselves a part of the team/athlete's or entertainer's journey. Some researchers have found that some fans become so tied to their teams/athletes or entertainers that they experience hormonal surges and other physiological changes while watching them perform. It is easy to see how fans would gravitate to and be heavy users of social networking sites, especially if they can share experiences with other like-minded people.

Additionally, multiplayer games have been played for their entertainment value and in some cases, the chance to win a prize, but it is also true that games are played as catalyst for social interaction, meaning people enjoy playing games but also enjoy the social interaction with friends and family that occur during the game play. Fantasy sports is a good example of this phenomenon where like-minded sports fans can not only share in the common theme of a sports game but lever the game experience as way to stay close to the other participants in the fantasy league as well as the individual players that make up their fantasy team. It could be said that games and social interaction have gone hand-in-hand since recorded time.

### SUMMARY

Given the above, it is appreciated that there exists a need for a system and apparatus that leverages the emergence of location aware technology, the advances in mobile technology and the now the seemingly ubiquitous use of the mobile web. This system and apparatus would allow fans to create a universal account to all events and venues thereby allowing them to social network amongst each other while being entertained at the venue through digital promotions while enjoying the show or game. The fan may perform actions at the venue and receive awards from a loyalty system. The fan could then be authenticated at the physical event by the location aware technology embedded within the mobile device and/or by any number of other techniques including but not limited to ticket authentication.

According to one aspect of the present invention, it is appreciated that social networking functions may be beneficial to fans in a stadium, venue or theater setting. In one implementation, a social network is provided to sports or entertainment enthusiasts that revolve around real-world fan participation in live events.

Because social networks are not designed for the in-stadium, venue or theater experience, one that integrates with the venue and the fan environment provides many benefits to both the fan and the entertainment or sports venue. In some implementations, such a social network may encompass the venue's in-house ticket management and CRM system, the fans' computer at home, a mobile device (e.g., a PDA, cell phone, etc.) and/or any other Internet-enabled or other communication-capable device.

According to another embodiment, such a system may qualify fans and may provide social networking features that are responsive to such a qualification. For instance, the fan may be qualified through an existing loyalty club or other frequent buyer program type. In one implementation, qualified fans include those who have chosen to join a particular, team, performance group or venue's fan loyalty club. In another example, such a system may require that a fan retain a certain status (e.g., attend a certain number of games or shows) in order to retain their qualified status which would allow the fan to participate in a social network.

Various types of social networking functions may be advantageous, especially in a stadium, theater or venue environment. For instance, it may be beneficial to be able to locate and identify other fans within the sports or entertainment location. In one example, a person may wish to know when a friend or family member is at a stadium, and where that person is sitting within the stadium. In yet another example, fan can view and comment on content created by other fans in real time (or near-real time) within the stadium, theater or venue environment, which may lead to fans enhancing their entertainment experience.

In another example, it may be beneficial to know, on a computer system, when and what a fan is doing within the stadium, theater or venue. In one example, a person located outside the venue location (e.g., operating a home computer) may view the status of a fan inside the venue location. In another example, a person located outside of the venue location may be permitted to interact or share content with the fan inside the venue location.

Further, it may be beneficial to allow a loyalty-based system to actively engage the fan within the venue location. For example, if the fan performs certain desired actions within the venue location, that fan may be provided an award. For instance, if the fan makes a qualified purchase within the venue location, (e.g., a stadium), that fan may receive an award. That award may be determined based on the action performed, but may be anything of value. As discussed further below, the loyalty system may award loyalty points to the user based on actions performed within a venue location.

In another embodiment, fans located at different venues may be permitted to communicate using social networking tools and other features described herein. For instance, fans at different locations may use such tools to communicate and perform various functions as discussed herein among a number of venues. Such locations, for example, include fans at basketball games taking place simultaneously in different cities, fans simultaneously camping on sidewalks in front of multiple theatres waiting in line to view a new movie release, or any other disparate venue locations.

In another implementation, the social network may permit fans to create a related gaming experience to events that occur on stage or on the athletic field. For instance, the social network itself may be permitted to accept wagers made between fans, and some of those wagers may relate to real-world events that occur within a stadium or other type of entertainment venue. For example, one or more fans interacting in the social network may be permitted to place wagers or take bets from other fans on a potential outcome of a game being played on the athletic field (e.g., betting whether there will be a “strike” thrown on the next pitch of a baseball game). To this end, a market for wagering may be created and supported by the social network. What is actually wagered could be determined by the laws governing the jurisdiction where the event is taking place. For example, wagers could have monetary value where lawful and where gambling is prohibited the wagers may have no monetary value other than bragging rights. There are many other examples where location information may be useful for enhancing the in-stadium or venue experience.

In another implementation, fans, teams, performers and/or the venue itself may be permitted to organize multiplayer games within the venue location using one or more social networking tools. In one example, a fan sitting in his or her seat may be provided social networking tools that permit the fan to organize his/her own game. For instance, the fan, through an interface of a mobile device, may communicate to other fans (for instance, their “friends”) who are also holding mobile devices to begin a sports quiz tournament. By providing the fan the ability to customize their experience with other fans, the opportunity to maintain the interest of the fan is increased.

In one aspect of the present invention, the user is permitted to interact with an application or service (referred to hereinafter as the “the service”) on their computer system (e.g., a mobile device) with upon which the service is executed. One or more services may be integrated with an application (such as a location-based game or other application) that spans multiple applications or services that execute on the mobile device. According to one embodiment, an application such as a location-based game or other application permits a user to receive some benefit in the application based on actions performed by the user in the multiple applications or services and/or actions performed at the venue location. That is, an application that integrates with other multiple applications or services that execute on the system may provide a benefit to the user based on the user's actions performed in these multiple applications, services, and/or venue location.

In one example implementation, the application includes a loyalty-based system that spans multiple applications or services by, for instance, tracking user interaction within the multiple applications or services executing on the computer system and/or actions performed at the venue location (e.g., during an event being held at the venue location). When users perform a desired action within the application or service executing on the computer system or otherwise takes a desired action within a particular venue, the user may be awarded loyalty points that the user can redeem for one or more benefits.

In another implementation, the application may also integrate with an ad network to display ads to the user in real time (e.g., at a venue location), and to generate awards that can be provided to users. Users may be permitted to accrue loyalty points or other value types while interacting with the multiple applications or services, and may be permitted to redeem these accrued points for awards having some value to the user. For instance, loyalty points may be exchanged in the system for products/services, discounts on products/services, gift cards, entries to games, entries to sweepstakes, free product samples, points in other loyalty programs or any other thing having value. Loyalty points may be accrued, for instance, if the user views a particular advertisement, watches an advertising video, receives other content from the advertiser, performs some action within the venue location (e.g., the user makes a qualified purchase, communicates with a person in the user's network, etc.) or performs some desired action.

According to one embodiment, the user may be awarded points that may be redeemed online via an interface of a mobile device (e.g., a smart phone). For instance, the user may be provided an interface that allows the user to check on his/her awards point balance, redeem points for various products, services, offers, discounts or any other thing of real value to the user. In one embodiment, points earned by the user may be redeemed at the venue location.

Further, because a standard interface is provided that permits a user to receive points from multiple providers and redeem points among a number of different reward providers, a more interesting and compelling rewards program is provided. For instance, the owner of a particular venue may desire to have a loyalty program that spans multiple events for that particular venue location (e.g., concerts, sports events, etc.). In one example, a venue owner may promote brand awareness by a loyalty program that is integrated with a user's mobile device that engages the user while the user attends the event, and provides awards to the user based on behaviors of the user with respect to the loyalty functions provided to the user at the venue location. Also, by providing a standard interface, the cost of development for a particular application is reduced as the awards program can be easily integrated within an application by the developer and can be used to support multiple entities (e.g., all NFL teams). In one example implementation, loyalty points accrued across various venues may be redeemed at any supported venue selectively by the user.

Notably, actions performed by the user among multiple applications and venue locations are monitored by a loyalty system that provides the loyalty awards responsive to those actions. In this way, loyalty programs may be standardized and easily implemented among application providers. In one implementation, an application programming interface (API) is provided that permits developers to define activities within their applications that should be monitored/rewarded by the loyalty system. The interface may be provided as a series of functions that, when executed, cause information to be communicated to a loyalty system regarding the behavior of the user. For instance, a developer may define a trigger that is activated when the user performs an action within an application, and a function signals the loyalty system when the action is performed (e.g., when the trigger is activated). To this end, an application platform may be provided which includes functions that can be included within an application that allow the application to communicate with the loyalty system.

Further, it is appreciated that applications provided on mobile computing systems such as smart phones have become very popular and that tracking of behavior among multiple applications is not currently possible. Advertisers that would like to target users based on their behaviors are not currently capable of viewing the behavior of a user across multiple applications. To this end, a system may be provided that tracks the behavior of the user across multiple applications and targets advertisements to be displayed to the user based on the knowledge of the user's behavior within each of the separate applications or within the venue location. Currently, application providers and venue location operators do not have a global view of the user's behavior, as they are limited only to their interactions with the user within their own application or venue locations. Because behavior is tracked among multiple applications and venue locations, that information may be communicated to an application provider or venue location operator.

For instance, in one embodiment, information relating to a user's behavior may be communicated to a social networking system and shared among other users in that particular user's social network. Thus, the social networking system may be provided a view of the user's behavior and the social networking system may perform functions based on the user's behavior. Also, a user may choose to share their activities (e.g., within applications, within the venue location) with their friends. In one example, a user may communicate their use of a particular application to another user in their social network and may provide their ratings of a particular application, share their preferences for particular applications, or share their usage of applications with others in their social network. For instance, a user's in-application activity may be communicated to users in the well-known Facebook social networking application/system or other social networking system. Award progress may be communicated to other people in the user's social network (e.g., in a leaderboard construct) to encourage increased application activity among people within the social network. In another example, a user's in-venue activity or status may be shared with other people in the user's social network.

According to other embodiments, a system that provides communication connectivity between a loyalty program and a social networking system may provide other additional benefits. For example, a loyalty system may provide loyalty points to a user responsive to the user performing a beneficial action with respect to his/her social network. For instance, the user may be provided loyalty points by the loyalty system responsive to the user forwarding an advertisement to someone in their social network. Because a platform may be provided that links social networking platforms with both a loyalty system and an advertising network, such functions are now possible.

According to yet another aspect, a status of the user may be provided responsive to actions by the user within the application. For instance, the user may be awarded points, badges, or other status responsive to the user's actions performed among a number of applications and/or within a particular venue location. According to one embodiment, application developers may be provided a facility to determine what awards are provided for specific actions. In some implementations, the application developer may define their own awards or currency within the platform. To this end, interfaces may be provided for application developers to define their own awards based on user behavior. Similarly, advertisers may provide points, badges, or other status to the user based on their actions. Such an environment may provide a universal tool for implementing loyalty programs responsive to application behavior performed by the user over multiple applications or venue locations.

In another embodiment, the platform may provide “skinnable” games that permit advertisers or application developers to more easily promote their applications, products, or services. Such games may provide additional entertainment value, promote brand awareness, and otherwise further the marketing goals of the provider.

According to one aspect of the present invention, a method operable by a computer system associated with a venue is provided. The method comprises acts of identifying, by a computer system, a user uniquely among a plurality of users, associating, by the computer system, the user with an entry in the venue, determining a location of the user in relation to the venue, and performing an action with respect to the user based on the user location in relation to the venue. According to one embodiment of the present invention, the entry in the venue includes a ticket, and wherein the method further comprises associating the user with the ticket. According to another embodiment of the invention, the ticket includes a unique identifier and wherein the computer system is operable to perform an act of associating the unique identifier with an identifier of the user. According to another embodiment of the invention, the method further comprises an act of creating an account for the user, the account including the identifier of the user. According to another embodiment of the invention, the method further comprises an act of storing, by the computer system, one or more elements associated with the user account including at least one of a group comprising a username, a password, demographic information, psychographic information, an identifier of a computer system associated with the user, a phone number, account information, a mobile identifier, and a biometric identifier.

According to one embodiment of the present invention, the act of determining a location of the user in relation to the venue includes acts of scanning, at the venue, a ticket associated with the user, and identifying the user as being located at the venue responsive to the act of scanning. According to another embodiment of the invention, the act of determining a location of the user in relation to the venue includes acts of accepting input from the user, at the venue, an entry identifier associated with the entry into the venue, and identifying the user as being located at the venue responsive to the act of accepting. According to another embodiment of the invention, the act of determining a location of the user in relation to the venue includes acts of determining, by a device associated with the user, the location of the user, and identifying the user as being located at the venue responsive to the act of determining. According to another embodiment of the invention, the act of determining a location of the user in relation to the venue includes acts of determining the location of the user, retrieve placement information for the venue, and identifying the user at a particular placement within the venue responsive to the user location and placement information for the venue. According to another embodiment of the invention, the method further comprises permitting the user to input a ticket identifier associated with the entry into the venue. According to another embodiment of the invention, the method further comprises permitting the user to take a picture of a ticket associated with the entry into the venue, and deriving information from the picture to determine the location of the user in relation to the venue.

According to one embodiment of the present invention, the act of determining a location of the user in relation to the venue includes an act of automatically determining the location of the user responsive to actions performed by the user within the venue. According to another embodiment of the invention, the method further comprises an act of storing purchasing information for the user and associating the purchasing information with the entry. According to another embodiment of the invention, the method further comprises an act of permitting the user to perform a purchase using information identifying the entry into the venue. According to another embodiment of the invention, the purchase information includes at least one of bank account, credit account, or debit account information associated with the user. According to another embodiment of the invention, the act of performing an action with respect to the user based on the user location in relation to the venue includes permitting the user to receive a promotion responsive to the location in relation to the venue. According to another embodiment of the invention, the method further comprises acts of determining a location of the user relative to a location of another at the venue and performing an action with respect to the user based on determined relative location. According to another embodiment of the invention, the act of performing an action with respect to the user based on the user location in relation to the venue includes communicating the user location to one or more other users.

According to one embodiment of the present invention, the act of performing an action with respect to the user based on the user location in relation to the venue includes communicating the user location to one or more other systems. According to another embodiment of the invention, the act of performing an action with respect to the user based on the user location in relation to the venue includes communicating the user location to a social networking system. According to another embodiment of the invention, the method further comprises an act of permitting the user to send a communication identifying the user location to a network of users associated with the social networking system. According to another embodiment of the invention, the method further comprises an act of permitting the user to locate other users that are located at the venue and are defined within the social network system. According to another embodiment of the invention, the act of performing an action with respect to the user based on the user location in relation to the venue includes communicating the user location to an entertainment system located within the venue. According to another embodiment of the invention, the act of performing an action with respect to the user based on the user location in relation to the venue includes offering membership to a loyalty program responsive to the user location in relation to the venue. According to another embodiment of the invention, the act of permitting includes permitting the user to purchase, at the venue using the information identifying the entry, at least one of food, drinks, parking, products and services. According to another embodiment, the act of permitting includes permitting the user to win via a game, earn via an action, or be given via marketing promotion at least one of food, drinks, parking, products, or services.

According to another aspect of the invention, a computer system is provided associated with a venue comprising a memory, a processor operatively connected with the memory for executing system components, including a component that stores, in the memory information identifying a user uniquely among a plurality of users, a component that associates the user with an entry in the venue, a component that determines a location of the user in relation to the venue, and a component that performs an action with respect to the user based on the user location in relation to the venue.

According to one embodiment, the entry in the venue includes a ticket, and wherein the system further comprises a component that associates the user with the ticket. According to another embodiment, the ticket includes a unique identifier and wherein the processor is adapted to associate the unique identifier with an identifier of the user. According to another embodiment, the system further comprises a component that creates an account for the user, the account including the identifier of the user. According to another embodiment, the processor is adapted to store, in the memory, one or more elements associated with the user account including at least one of a group comprising a username, a password, demographic information, psychographic information, an identifier of a computer system associated with the user, a phone number, account information, a mobile identifier, and a biometric identifier.

According to another embodiment, the system further comprises a scanner operable to scan, at the venue, a ticket associated with the user, and wherein the system includes a component that identifies the user as being located at the venue responsive to the scan of the ticket. According to another embodiment, the system further comprises a component that accepts input from the user, at the venue, an entry identifier associated with the entry into the venue, and a component that identifies the user as being located at the venue responsive to the acceptance of input from the user.

According to another embodiment, the system further comprises a user device that is configured to determine the location of the user, and wherein the system includes a component that identifies the user as being located at the venue responsive to determining the location of the user. According to another embodiment, the system further comprises a component that determines the location of the user, retrieve placement information for the venue, and a component that identifies the user at a particular placement within the venue responsive to the user location and placement information for the venue.

According to another embodiment, the system further comprises a component that permits the user to input a ticket identifier associated with the entry into the venue. According to another embodiment, the system further comprises a component that permits the user to take a picture of a ticket associated with the entry into the venue, and a component that derives information from the picture to determine the location of the user in relation to the venue.

According to another embodiment, the system further comprises a component that automatically determines the location of the user responsive to actions performed by the user within the venue. According to another embodiment, the system further comprises a component that stores purchasing information for the user and associating the purchasing information with the entry. According to another embodiment, the system further comprises a component that permits the user to perform a purchase using information identifying the entry into the venue. According to another embodiment, the purchase information includes at least one of bank account, credit account, or debit account information associated with the user.

According to another embodiment, the system further comprises a component that permits the user to receive a promotion responsive to the location in relation to the venue. According to another embodiment, the system further comprises a component for determining a location of the user relative to a location of another at the venue and a component for performing an action with respect to the user based on determined relative location. According to another embodiment, the system further comprises a component that communicates the user location to one or more other users. According to another embodiment, the system further comprises a component that communicates the user location to one or more other systems.

According to another embodiment, the system further comprises a component that communicates the user location to a social networking system. According to another embodiment, the system further comprises a component that permits the user to send a communication identifying the user location to a network of users associated with the social networking system. According to another embodiment, the system further comprises a component that permits the user to locate other users that are located at the venue and are defined within the social network system.

According to another embodiment, the system further comprises a component that communicates the user location to an entertainment system located within the venue. According to another embodiment, the system further comprises a component that offers membership to a loyalty program responsive to the user location in relation to the venue. According to another embodiment, the system further comprises a component that permits the user to perform a purchase using information identifying the entry into the venue.

According to another embodiment, the component that permits the user to perform a purchase permits the user to purchase, at the venue using the information identifying the entry, at least one of food, drinks, parking, products and services. According to another embodiment, the component that permits the user to perform a purchase permits the user to win via a game, earn via an action, or be given via marketing promotion at least one of food, drinks, parking, products, or services.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of a distributed network capable of implementing various aspects of the present invention;

FIG. 2 shows an example process for integrating users at a venue according to one embodiment;

FIG. 3 shows an example process for performing actions based on a user's location within a venue according to one embodiment;

FIG. 4 shows one implementation of a system that provides ads or promotions to a user at a venue location;

FIG. 5 shows o ne example of a system that permits game playing while the user is located at a venue location according to one embodiment;

FIG. 6 shows one example of a system that communicates with other users according to one embodiment;

FIG. 7 shows a block diagram of a system capable of implementing various aspects of the present invention;

FIG. 8 shows a block diagram of a system for performing an application platform that spans multiple applications and services according to one embodiment;

FIG. 9 shows a flow chart of an exemplary method for performing a mobile, location-based game according to one embodiment;

FIG. 10 shows a flow chart of an exemplary method for awarding a user responsive to an action performed within an application;

FIG. 11 shows a flow chart for providing awards and associating them with application behaviors according to one embodiment;

FIG. 12 shows a flow chart for monitoring user behavior according to one embodiment;

FIG. 13 shows a flow chart for monitoring user behavior according to another embodiment;

FIG. 14 shows a flow chart for monitoring user behavior according to another embodiment;

FIG. 15 shows an example user interface according to one embodiment;

FIG. 16 shows another example user interface according to one embodiment; and

FIG. 17 shows an example implementation for monitoring and rewarding user behavior according to one embodiment.

### DETAILED DESCRIPTION

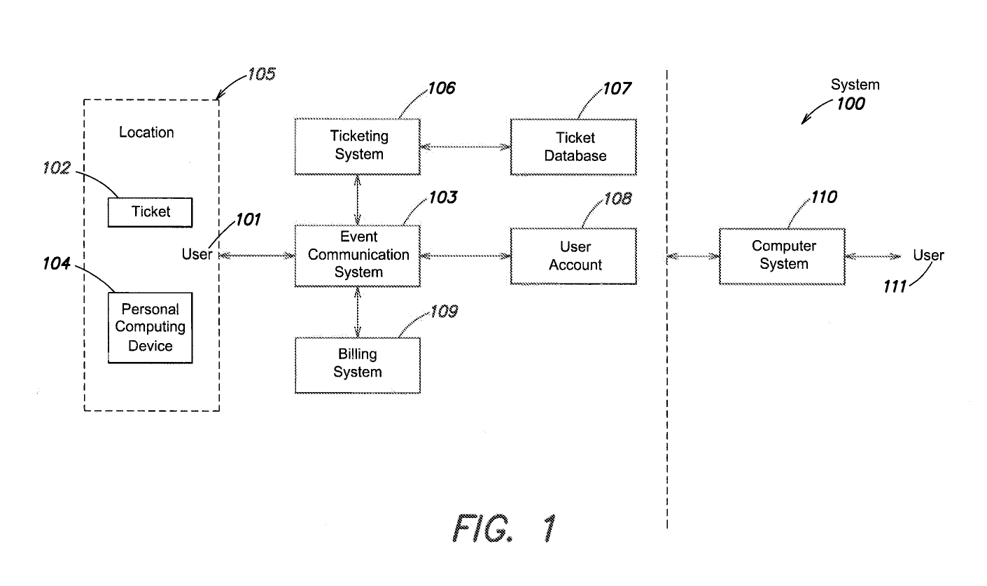

These and other embodiments may be implemented on one or more computer systems. For instance, various aspects of the present invention may be practiced in a distributed network as shown by way of example in FIG. 1. In particular, FIG. 1 shows a system 100 including a user 101 that attends a venue such as a sports arena, stadium, or other type of venue. As discussed, the user may attend a sports or other entertainment event being conducted at the venue. The user may also operate a personal computing device 104 such as a cell phone, PDA, tablet computer, or other computing device type.

According to one aspect of the present invention, a system 100 may use a location of the user (e.g., location 105) and an entry into a venue (e.g., a ticket 102) to determine one or more actions that can be performed by the system with respect to the user. In one aspect, the user's location in relation to the venue and/or other users may be used to perform particular actions. Such actions may include, for example, conducting communications between users located both within and outside of the venue, communicating the player's location to other systems and users, playing games within the venue, among other actions.

Optimally, some functions may be performed in association with a user's personal computing device (e.g., device 104) such as a cell phone. The user's personal computing device may be useful in determining the user's location in relation to the venue. For instance, the user may be located within the venue (e.g., in a particular seat location) or around the venue (e.g., in a parking lot where tailgating occurs, near a cooperating business near the venue, on a highway leading to the venue, etc.).

This location information may be determined from the computing device if the device has such a capability. For instance, the device may have a GPS capability, WiFi triangulation, and/or any other method(s) or combination of methods to determine a device location. The device may also be useful for other functions, such as providing communication functions, permit the user to receive ads from the vendor operator or other advertisers, play games, and perform display functions to enhance the user's experience.

If the user's location is known, the user may be more effectively engaged by the venue operator or other provider interested in engaging the user. The user's location may also be inferred if the user is associated with a particular ticket, and that user performs an action with respect to the ticket. For example, the user can have the ticket scanned at the venue and that user may be determined by the system to be at the venue location. For instance, a ticketing system (e.g., system 106) may provide ticket information within a distributed computing system (e.g., system 100). Such ticket information may be stored in a computer system, and may include, for example, a ticket database 107 including, without limitation, venue location information correlated to ticket identifiers. Ticketing system 106 may include a system located at the venue, but also may include one or more ticket-based services such as Ticketmaster, Stubhub, RazorGator or other system that stores ticket information.

In another embodiment, a person may be identified as being at a particular location through the actions of other players. For instance, one user spots Michael Jones, which puts him at that location, and that person's location is updated in the system. A person may also be associated with a group of people, and through the actions of one person, the location status of other people within the group may be updated.

As discussed above, if the location of the user can be determined within the venue, that user may be more adequately engaged by marketers, the venue operator, other users inside and outside of the venue. To this end, a system may be provided that manages communication with the user wile attending an event within a venue. For instance, an event communication system 103 may be provided that is configured to perform a number of actions in relation to the user.

In one example, event communication system 103 may be capable of communicating with a user via one or more personal computing devices such as a cell phone. In one example implementation, the event communication system may communicate using one or more protocols. For instance, event communication system 103 may communicate using any number of communication methods including TCP/IP via WiFi or other type of network, SMS, email or any other type of messaging method.

Users defined within distributed system 100 may have a user account (e.g., user account 108) associated with each user. The system may allow a user to establish an account on one or more computer systems associated with the service. This account may serve as the master account for all locations and events where the user elects to visit and/or participate in. The account could contain some or all of the following information: username/password, address of the user, demographic information, psychographic information, MAC address (or similar identifier) of the mobile device, mobile device phone number, valid credit or debit card number, biometric ID, RFID, or other information.

The account could also track the user's attendance history for multiple events and that information may notably determine rewards, advertisements and/or promotions that are provided to the user in the future (e.g., by a loyalty system). This stored information may be used to determine levels in a rewards program, for the purpose of encouraging the user to continue patronage of a particular venue by a loyalty system.

Indeed, one problem associated with sporting events and other venues is targeting the occasional fan that is not identified as a regular patron (e.g., not a season ticket holder), and therefore, by tracking multiple attendance of the user to multiple events, some of which may be among different ticket vendors and venues, that user may be more adequately targeted and engaged. For instance, information that may be tracked may include purchasing behavior of the user, total amount spent by the user (e.g., over time or on a per event basis), seating preferences within particular venues, communication preferences, team affiliations, sporting interests, or other information that may be used to more effectively engage the user. By storing such information and providing this information to providers, a more holistic view of the user may be formed, and the user may be engaged by these providers accordingly.

According to another aspect, the distributed system may associate other “venues” with a particular venue as being related to the venue. This may be performed so that these other venues can also participate in a promotion tied to a particular venue. For instance, if a user qualifies or authenticates himself/herself properly to the venue, that user may participate in a promotion that extends among multiple related venues. For instance, there may be a particular promotion that relates to sales of products/services to the user relating to a particular event. In a particular event, a user may receive a gift card or discount if the user spends more than $500 across multiple venues related to the event (e.g., the user eats lunch at a restaurant before the game, buys refreshments at a concessions stand while in the game, buys souvenirs at a stand outside of the stadium, etc.).

Users may also be permitted to pay for goods and/or services while attending the event. To this end, system 100 may include a billing system 109 that is capable of billing an account of the user for goods and services ordered by the user at the venue. In one embodiment, an association between the user's account information and the ticket for the event may be made that allows the user to order goods and services using only their ticket identifier. For instance, when the user swipes a barcode of a ticket at a food stand, the user's credit card number and related information is retrieved and used to pay for the order placed by the user.

In another implementation, the user may be permitted to order goods and services using only their mobile device (e.g., a smart phone). The mobile device may include one or more interfaces through which the user may order such goods and services, and these ordered goods and services may be delivered to a verified location of the user within the venue (e.g., in an identified seat indicated by the ticket). The mobile device may also present within the interface, a barcode that may be scanned at the venue to pay for goods and services.

As discussed, the user's location within the venue may be used to determine what actions may be performed with respect to the user. To determine the user's location, the user may manually input or scan a ticket bar code or other unique identifier into the distributed system. This may include having the distributed system authenticate the barcode or other unique identifier as belonging to a valid ticket. To this end, the system may include a barcode scanner or other device used to read an identifier of the ticket.

Based on the particular ticket, the system may then determine the location of the user within the venue. The system may also retrieve a seating or placement information to place the user in the seat assignment for a particular event. Other methods may be used to place the user at a particular location including a GPS device, triangulation between cell towers, WiFi information, RFID, or other location method, either alone or in combination with other methods. The system may also be capable of authenticating that the elevation detected by the device is consistent with the venue and the seat assignment at the venue. The system may also authenticate the user's mobile device, such as by MAC address (or similar identifier) of the mobile device, mobile device phone number, or any other information.

The user may manually check in to a particular location. This may be done, for example, by inputting or scanning the ticket bar code or a code on the user's seat, taking a photo of the ticket or seat code, or by entering some other venue-specific identifier into the system. In one embodiment, the system may authenticate the barcode or other unique identifier as belonging to a valid ticket. The system may also retrieve the seating or placement information to place the user in the seat assignment for that event. The system may authenticate the geographic location by one of many methods, including GPS, triangulation between cell towers, WiFi information, among others. Further, the system may authenticate that the elevation is consistent with the venue and the seat assignment at the venue.

According to one aspect, it is realized that theaters, stadiums, and other venues are big business having captive audiences that can be more adequately marketed and entertained. Systems and methods may be provided that maximize advertising, sales revenue, and entertainment for such users while attending the venue. According to one embodiment, the system may provide complete analytics, by obtaining critical data on what users are sitting in their seats, what kind of events they are coming to, who is coming with them, and what the users are buying. According to another aspect, each venue would include an online social network focused on events, venues and social ticketing, including functionality like event management, invitation facilitation, ticket management and ticket transfers. This capability would enable and encourage strong social dynamics among event attendees. Further, an “invite” service may be provided that serves fans and providers in the sports and entertainment ticketing industry. Fans may use the service to create invitations for ticketed events, track responses, and social conversations around an event.

The system may provide one or more of the following features. For instance the system may allow the user to associate a credit or debit card or some other credit or debit facility to the ticket purchase. In another example, the system may allow the user to participate in digital promotions based on their seat assignment or presence at the venue. For instance, there may be a “magic seat” or other type of promotion where a user located in a particular venue location receives a prize.

The system may also use location information of its users at the event to permit the user to utilize the “what's near” (e.g., based on information about the venue) or “who's near” (e.g., based on other users checking into the system). The system may also allow the user to broadcast to other social networks that they are now attending an event and their ticket to the event has been authenticated. Thus, the system may permit interaction between users located outside of the stadium or other venue type and users attending the event. The system may allow the user to find other friends who have checked in using this system or other social networks and display their location based on the information available.

The system may permit other types of communications, such as allowing users to communicate with each other over the system before, during and/or after the event (e.g., in the parking lot, tailgating location, etc.). To this end, system 100 may be coupled to one or more computer systems (e.g., system 110) operated by one or more users (e.g., user 111) located outside of the venue. In yet another embodiment, the system may allow users to communicate with performers over the system before, during and/or after the event (e.g., send a text message to a particular player). In yet another embodiment, the system may allow the venue operator and/or the user to broadcast their communication stream to the venue's in-house audio visual system and to broadcast systems. For instance, a message or other indication (a “defense” chant button) when sent or selected by a user from their mobile device may be displayed within the venue.

The system may also allow users to share information and media files over the system before, during and/or after the event. For instance, the system may allow a user to post a picture in an online database that may be viewed by other users inside and outside of the venue. Further, the system may be leveraged by the venue operator to communicate information to users created on a venue customer service communication channel. In another aspect, a user may also be offered membership in a customer loyalty program based on attendance at a particular venue or attendance at various venues.

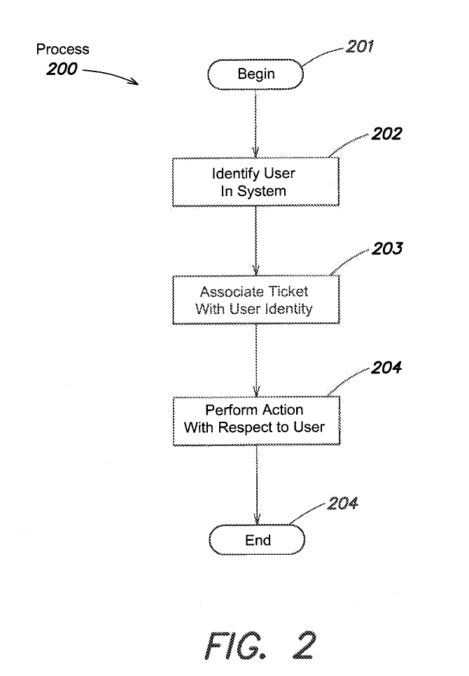

FIG. 2 shows one example process for integrating users at a venue. At block 201, process 200 begins. At block 202, the system (e.g., system 100) identifies a user in the system. For instance, the user may be identified uniquely within a system and his/her information may be stored in a user account as discussed above. At block 203, the system associates a ticket for an event being conducted at the venue with an identity of the user. Once the user is associated with the venue, various actions may be performed with respect to the user at block 204. At block 205, process 200 ends.

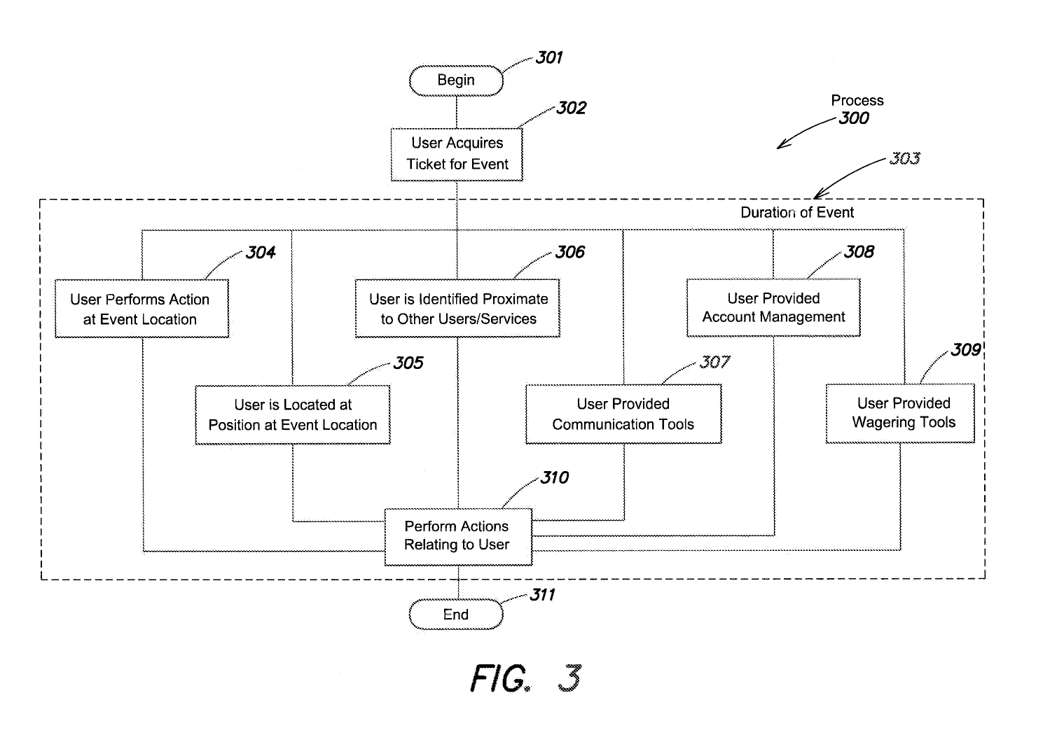

As discussed, once the user is associated with an entry into the venue, a system may be capable of performing one or more actions associated with the user. FIG. 3 shows a process 300 according to one embodiment that allows one or more actions to be performed by a system (e.g., system 100) responsive to a user's location within the venue. At block 301, process 300 begins. At block 302, a user acquires a ticket for an event which occurs at some point in time at a venue.

At some point, if the there can be determined an association with the user to a particular ticket for the event, this association may be stored in a database. In one example, a user buys a ticket online (e.g., StubHub, Ticketmaster, etc.) and an association is made between a user account and the ticketed event. In another example, the user themselves actively “check-in” using the ticket, such as by logging in to a service and entering a ticket ID, taking a picture of the ticket to be scanned by a system, or otherwise providing the ticket information to an online system.

Conventionally, it is appreciated that venues do not adequately engage the user during the duration of the event, as most of the focus to the attending user is selling tickets to the user prior to the event, and in-event sales at the event that are performed in a conventional manner (e.g., selling food/drink at a stand with no knowledge of the user). In one embodiment, the user is more adequately identified during the event (e.g., during a period of time representing the duration of the event 303), and actions that benefit the event and/or venue operator are performed. Further, the user is engaged to provide better services and an increased level of communication and engagement. In another embodiment, such actions may also be taken during periods prior to and after the event, and/or proximate to the location of the event, in order to provide a more fulfilling engagement of the user.

As shown in FIG. 3, a user may perform an action at the event location at block 304, and responsive to the action, the system may perform an action relating to the user at block 310. Such an action performed by the user may include, for example, entering the event using a ticket (e.g., at an entrance where the ticket is physically scanned by a scanning device). It may be known prior to the event that the particular ticket scanned is owned by the user, so when the ticket is scanned, the known location of the user may be updated with the venue location information (e.g., an action may be performed). Further, another action that may be performed may include the system posting the location of the user to a website, sending a message to other users that the user has arrived at the venue location, or other action.

The user may perform other actions at or near the event location that cause other actions to be performed. One action by the user that may cause other actions includes the movement of the user throughout the venue. At block 305, a user may be located at a particular position within the event location. For instance, the user may be located at his/her seat, at a concession stand (e.g., by electronic location detection of a personal computing device, a purchase made with a ticket, credit card, NFC device, mobile device, etc.). Also, a user's location may be detected by a mobile device, detectors within the environment (e.g., WiFi access point) or a combination of elements. When this location is known, various actions may be performed, such as being shown an advertisement, offered a promotion, coupon, or other benefit.

Also, the user may be identified proximate to other users and services at block 306. For example, a user's “friends” that are also attending the event may be identified and stored by the system. Similar to the user, their locations and actions may be tracked by the system, and functions based on their relative location to the user may be determined and used to provide additional functions to the user (e.g., a “where are they” function that located other users, an ordering system that permits users to buy goods/services for other users, an advertising function that is location-aware and displays ads in real time to the user based on their location within the venue, a “where is the nearest restroom” function, etc.).

The system may provide a number of communication and/or location based services to enhance the user experience during the event (or proximate to the event's occurrence and/or location). The system may also provide one or more communication tools (e.g., at block 307) for communicating with other users located at the event or outside the event. These tools may permit users to perform in-event communications, such as sending messages between users, purchasing goods or services for other users to be delivered at other user's locations within the event, displaying updates to user's outside the event, sending video, pictures and sending other communication types.

Further, the user may be provided one or more account management tools that enable the user to more conveniently make purchased during the event for goods and services. For instance, an application program that executes on a personal computing system may be provided that associates a credit or debit account to a ticket for the event, such that display or use of the ticket at the event allows a system to access the user's account information to complete a purchase. The user may also be provided one or more tools (e.g., an application program executing on a mobile device) that permits the user to receive and/or redeem awards, view loyalty programs statuses, review purchases, review attendance at events, among other capabilities.

In jurisdictions or locations that permit wagering, there may be provided wagering tools (e.g., at block 309) that allow a user to wager against other players and/or the house. Such wagers may relate to the event and may be determined by the player and/or house and may also relate to the event itself (e.g., wager based on actual game events, such as whether the team will score a touchdown on the next play, make a field goal, get a first down, etc.). During the period of the event 303, the system may continually evaluate actions and player location, and perform any number of actions in a continuous manner At block 311, process 300 ends.

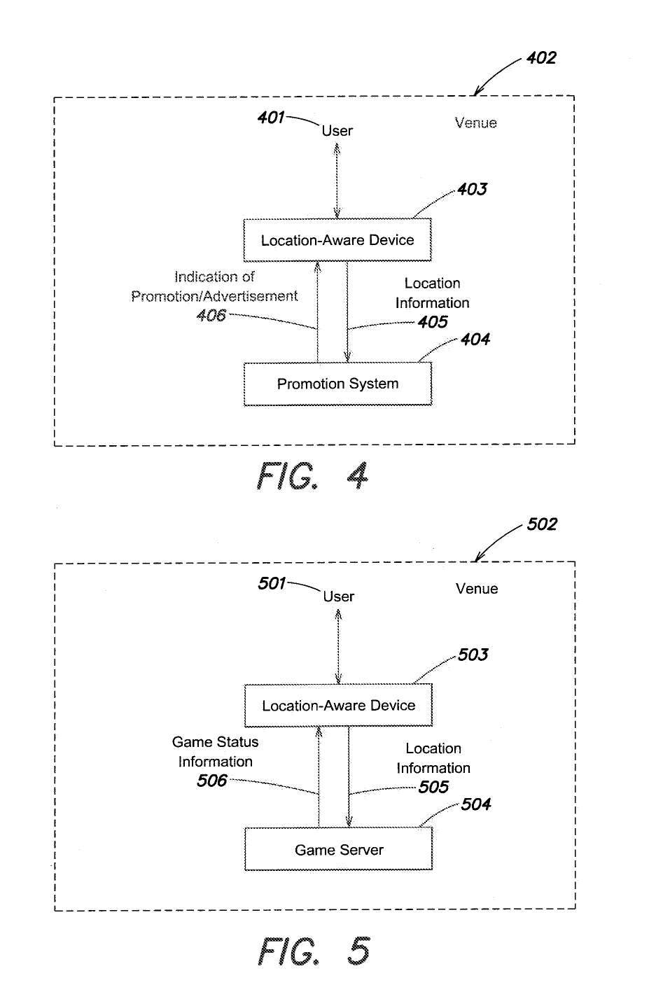

FIG. 4 shows one implementation of a system according to one embodiment of the present invention. At a particular venue location 402, a user 401 may have a location-aware device 403, such as a cell phone, smart phone, tablet or other type of computing device. Location information 405 may be communicated to a promotion system 404, and based on the location of the user, an indication of a promotion or other advertisement 406 may be sent and displayed to the user. This may permit, for example, more targeted advertising be shown to the user based on their location within the venue. Such promotions may be based on information in addition to the user's location, such as, for example, preference and/or behavioral information that may be stored in their account, purchase history, demographic information, or other information. As discussed, such promotions may be displayed in the form of an email message, an SMS message, an application window displayed in an interface of device 403, a display of a kiosk located within the venue, or other method.

In yet another implementation, the user's location may be used to play games while the user is located at the venue location 502 as shown in FIG. 5. At a particular venue location 502, a user 501 may have a location-aware device 503, such as a cell phone, smart phone, tablet or other type of computing device as discussed above. Location information 505 may be communicated to a game server 504, and based on the location of the user, game state information 506 may be sent and displayed to the user. For instance, an “easter egg” game may be provided where virtual eggs are located within a venue, and prizes may be awarded for collecting certain ones or amounts of these eggs. Such a game may be executed and displayed to the user on a display of device 503, and based on the user location and/or other input information (e.g., input by the user), the game status may be changed and updated within the display. Such games may also be multiplayer, involving players within a particular party, or may include different sections of the venue and the users that are located therein (e.g., all of the users located in section 107). For instance, a virtual balloon toss game may be provided where groups or sections of users compete against each other and the result of the game is displayed to other users (e.g., displayed on an in-event display such as a jumbotron during a timeout in the game event). In some examples, awards such as hats, t-shirts, or other products or services may be provided to winning players or sections of players. In this way, the user may be more adequately entertained and engaged by the venue operator or other advertiser.

In yet another embodiment, users may themselves create virtual items, prizes, and/or currencies to engage with other users, at the venue. For instance, users may be able to leave virtual items in particular locations at the venue that other users can find and collect as part of a virtual item game. For instance, a user's mobile device may include application components that identify a location as provided by the user's mobile device, and a component may be provided that allows the user to identify a virtual item that is placed at the location identified by the device. Another user that arrives at the location after the virtual item is placed may be permitted to view and/or collect the virtual item.

In another example, users may make virtual wagers with other users. For instance, each ticketed user may be provided a fixed amount of virtual “cash” that could be wagered during the event. Each user may be permitted to create or offer a wager for another user with a payout determined by the user, or provided by the system. A user may use winnings to purchase entries in a sweepstakes that can provide one or more prizes. There may be other variations of games that may be provided that enhance the user experience and/or provide for social interactions and opportunities to win prizes.

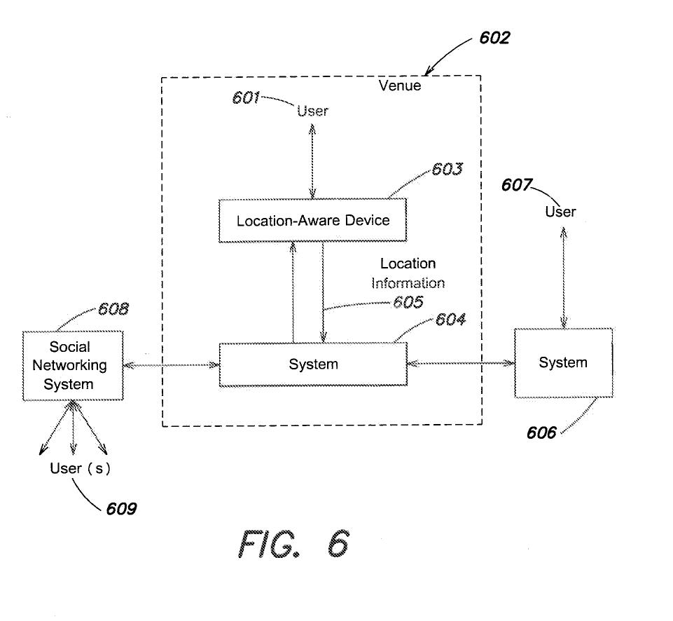

In yet another example implementation, the user may be engaged with other users that communicate with the system (e.g., system 100). FIG. 6 shows one implementation of a system that communicates with other users. At a particular venue location 602, a user 601 may have a location-aware device 603, such as a cell phone, smart phone, tablet or other type of computing device as discussed above. Location information 605 may be communicated to a system 604, and based on the location of the user, any communication, application data, or other information may be sent and displayed to the user. System 604 may be coupled to one or more other systems, user devices, etc. located within the venue 602 or outside of the venue for the purpose of entertaining and engaging users attending the event and other users located outside of the event (e.g., at home). For instance a user 607 may operate a computer system 606 (e.g., a PC) at their home and may be provided one or more communication tools in order to more effectively communicate with the user. One application that may be used by user outside the venue may include a user locator tool that shows the location of the user within the venue. Another tool may permit the outside user to receive pictures and/or video from the user attending the venue.

In another embodiment, system 604 may be coupled to a social networking system 608 that is configured to communicate with one or more users 609. For instance, the well-known Facebook, MySpace, Foursquare, or other applications may be adapted to receive updates from an in-venue application and/or system that permits information collected at the venue location to be communicated to social network users. For instance, the user takes a picture at the venue, and the picture is automatically stored in an event page associated with the user's Facebook page. This event page may be automatically created by the system located at the venue. In yet another example, the user's location may be communicated to a location-aware application (e.g., Foursquare) and the user may be automatically checked in to that location based on actions performed within the venue.

In yet another embodiment, system 604 may be coupled to or otherwise include one or more systems located within the venue 602. For instance, system 604 may be coupled to an in-game entertainment display (e.g., in a section of the user, a jumbotron, or other display) such that messages or other inputs may be displayed. Fans located within a venue may also be permitted special communication capabilities with athletes that are only made available within the venue. Also, enhanced communication may be provided between users, such as applications that leverage the player's location within the venue.

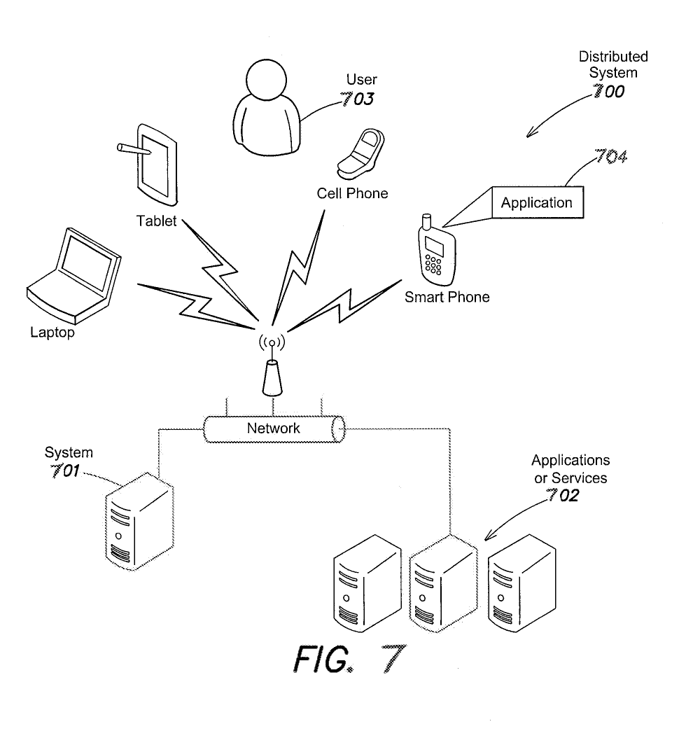

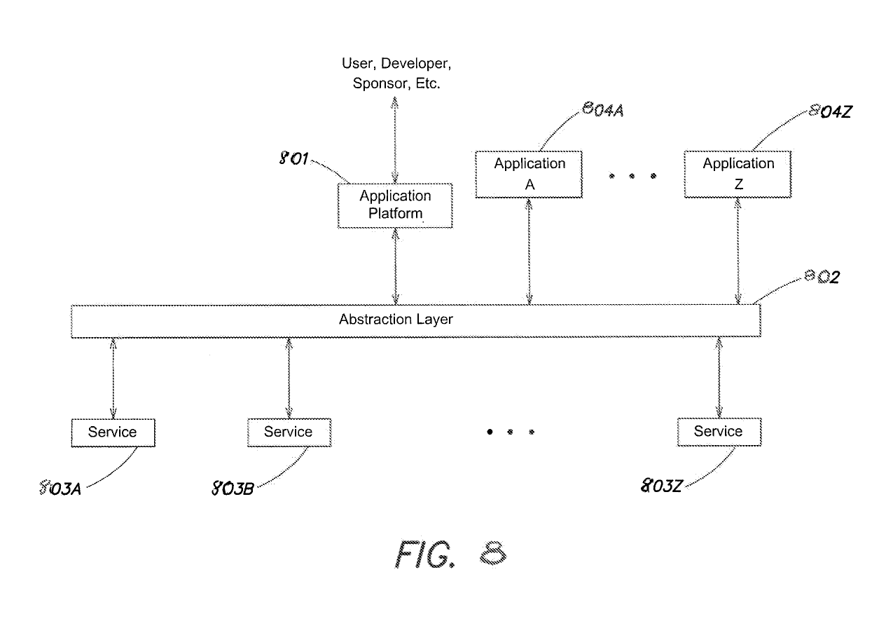

FIG. 7 shows a distributed system 700 in which various aspects of the present invention may be practiced. In particular, a distributed computer system 700 may be provided that allows a user 703 using one or more computer systems (e.g., a mobile device such as a tablet, laptop, smart phone, cell phone, or other device) to operate one or more application programs (e.g., application 704). For instance, the application may include applications that perform particular functions, and these applications may be downloaded and executed on a mobile device.

According to one embodiment, actions performed by the user in one or more applications (e.g., applications 704) may be tracked and integrated with one or more loyalty, advertising and/or game playing services provided by one or more systems (e.g., system 701). The applications may access interfaces provided by a loyalty system which allows users to receive awards based on actions taken by the users within the applications. Further, the loyalty system may be coupled with an advertising network that can deliver advertisements to the mobile device. In one embodiment, the user is provided some loyalty program benefit responsive to ads displayer to the user, other interaction with advertisement information (e.g., playing an advertisement-themed game), or interaction with the application itself (e.g., a badge awarded to a fan).

In one embodiment, the application that spans multiple applications or services may be a location-based game The location-based game may be coupled with one or more location based services, such as, but not limited to mapping and/or navigation programs (e.g., the VZNavigator application provided by the Verizon Wireless network, Google maps, Yahoo! Maps or other application), location-based check-in services (e.g., Facebook Places), location based What's Near services (e.g., Where application), location-based asset tracking services, or any other type of location-aware application that is capable of processing location information. According to one embodiment, the location-based game may be associated with multiple location-based services 702.

According to one aspect, the location-based game may permit the user to interface with one or more of these location-based services to play the game. For instance, when the game relates to locating game elements in various locations, representations of those game elements may be presented within each of the interfaces associated with the respective location-based services. For instance, a representation of a game element may be displayed in a Google maps interface as well as a Foursquare interface. Players (users) may interact separately with the location-based applications, but yet still see and interact with common elements of the location-based game. For instance, when the game involves collecting items (e.g., prizes), graphical representations of the items may be displayed in each interface of the separate location-based applications. In another embodiment, a loyalty system may permit the user to interface with one or more applications and/or services to receive loyalty awards. In one embodiment, the user may interact with the applications in a traditional way, but may receive loyalty rewards which interacting with the applications and/or services.

Distributed system 700 may also include one or more computer systems (e.g., system 701) that are used to conduct loyalty program, advertising and game functions, save data between applications (e.g., loyalty information, advertising performance data and data relating to gaming sessions), persist data when mobile devices are not connected, interface to social networking systems (e.g., Facebook, Twitter) store triggers, events, behavior data, rules of any games, among other functions. According to other embodiments, computer systems may be provided that permit an application provider to integrate loyalty program functions and advertising functions within their applications, and define awards to be provided to users based on their actions within applications. Further, computer systems may be provided that enable a game sponsor to create and sponsor games on a game development system. In such a system, the game sponsor may define rules, define/input prizes, and other aspects of the location-based game.

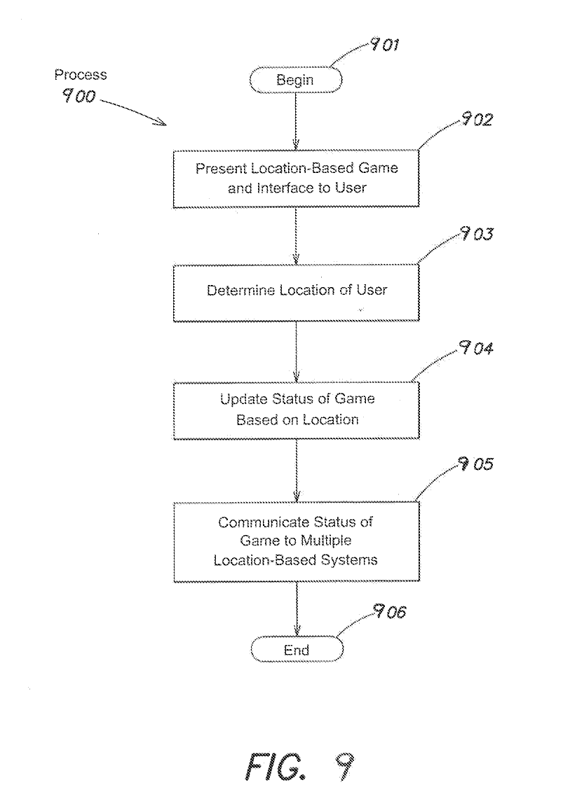

FIG. 8 shows an example system for supporting an application according to one embodiment of the present invention. For instance, an application platform 801 may be provided that permits a user (e.g., a developer, sponsor, game player or other user type) to create, monitor, and participate in loyalty programs that span one or more applications, services, and/or venue locations. Platform 801 may include an abstraction layer 802 to hide details of the loyalty program, advertising delivery, social networking integration, and game implementations from application developers. Such details may include application or service implementation details that are specific to the application or service used. For instance, presentation of an item on a graphical user interface may be different from the VZNavigator application interface versus the interface used in Google Maps. Further, a communication in Twitter may be easily performed from different applications using a common interface.

Information may be passed through the abstraction layer 802 (e.g., via an Application Programming Interface (API)) back and forth between the application platform and any number of applications (e.g., applications A-Z (items 804A-Z)) or services (e.g., services 803A-803Z such as a location-based service or social networking service). Such information may include information relating to loyalty program information, events triggered by a users while performing actions within applications, ad content communicated to mobile devices, videos, or other ad data, game elements, location-based information relating to the user, actions performed within the interface (e.g., movement, creation, deletion, modification of game elements) that are translated between multiple destinations within the distributed computer system (e.g., system 700).

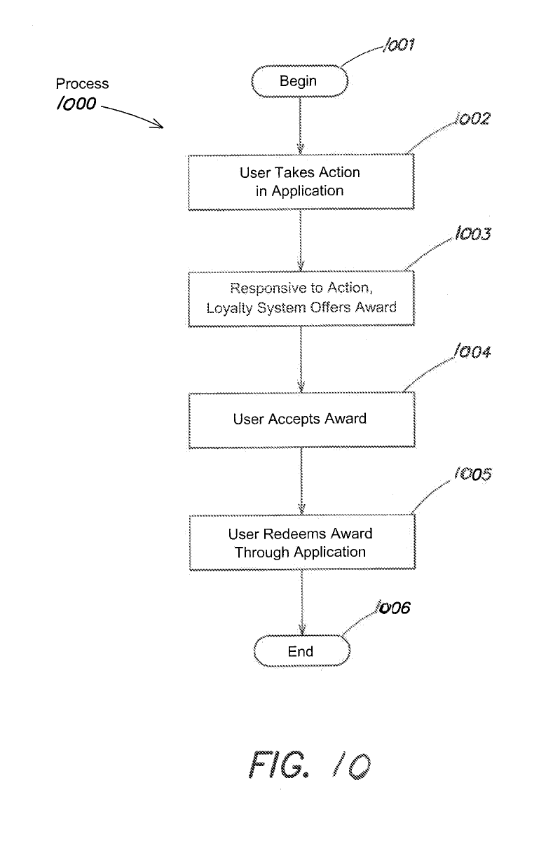

FIG. 9 shows a process 900 for performing a mobile, location-based game according to one embodiment. At block 901, process 900 begins. At block 902, the system (e.g., on a mobile device) presents a location-based game and corresponding interface to the user. In one example implementation, playing of the game may be permitted if the user is located at the venue location during a specified event. For instance, the game may include an item collecting game wherein the user collects items within a predetermined range of the user's actual location within the venue location as determined by a location function. This location function that determined the user's location may include a GPS function, cell tower triangulation function, GSM localization function, Bluetooth, Wifi, RFID or other location determining function performed by a mobile device (e.g., smart phone). Alternatively, a location-based function may be performed by systems other than the mobile device that place the user at a particular location.

At block 903, the system (e.g., the mobile device) may determine the location of the user, and at block 904, the system may update a status of the game based at least in part on the location of the user. In the example of the item collection game, an interface of the item collection game may be changed to show items that may be collected by the user based on the user's current location. The user may perform functions associated with that item at the location, and the game status may be further updated, and information may be sent to other location-based systems at block 905. In one example, state information relating to the game may be persisted to a memory of a game-playing computer, and state information may be downloaded as necessary to other game-playing devices when such devices are located at particular locations. State information may be communicated to other location-based services, and therefore the state of the game can be communicated to other users using the location-based services. Generally, blocks 902-905 may be performed repeatedly as the game persists, with the game state being updated in parallel by multiple players. At block 905, process 900 ends, such as when the game is terminated, there is/are one or more winners determined, or other game-terminating event.

As discussed above, the game may include an opportunity for a user to win and to place a chance to win within the location-based game. This may involve the user being permitted to place an item or other game element in a location where the user is located (e.g., as determined by a mobile device). In one embodiment, there is an opportunity for a user to win across a plurality of location-based systems (LBS) and to place a chance to win across a plurality of LBS systems. In this manner, the game may be shared among multiple applications and system types and interest in the game will be increased.

According to one embodiment of the invention shown in FIG. 10, a process 1000 is provided that allows a loyalty system to provide an award based on user actions within an application program and/or at a particular venue location. At block 1001, process 1000 begins. At block 1002, a user takes an action within an application. For instance, the user may open an application, perform a particular function within the application, or perform any other action that is desired by an application developer.

At block 1003, in response to the action performed by the user within the application and/or an action taken by the user within the venue location, a loyalty system may offer an award to the user. For instance, the application may display to a user within an interface of a mobile device that an award can be accepted based on the user's behavior within the application. At block 1004, the user accepts the award (e.g., by selecting a control within the interface that causes the award to be associated with the user). After accepting the award, that award may be redeemed (e.g., at block 1005) through one or more application interfaces. In one embodiment, a standard user interface is provided to the user for redeeming, monitoring, and interfacing with the loyalty system. At block 1006, process 1000 ends.

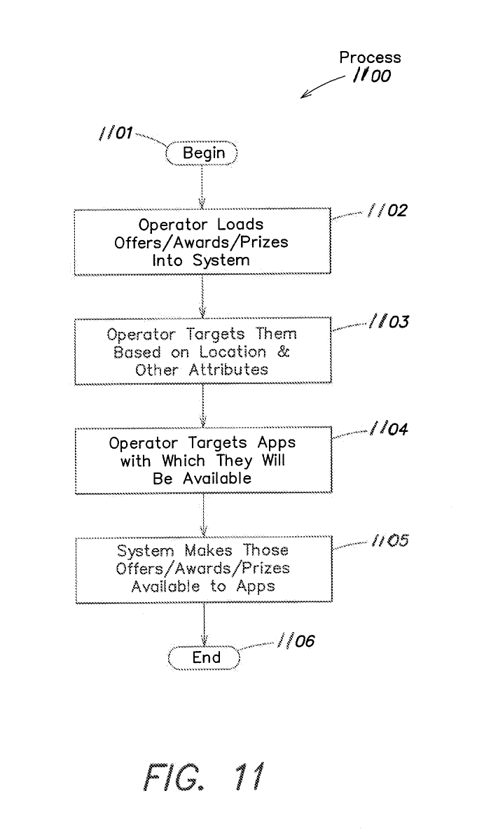

FIG. 11 shows a flowchart for providing awards and associating these awards with application behaviors according to one embodiment of the present invention. At block 1101, process 1100 begins. At block 1102, an operator loads offers/awards/prizes into the system. For instance, the operator may include an advertiser, application provider, or some other user that is capable of configuring awards or other benefits to be provided to the user. At block 1103, and operator targets particular offers/awards/prizes based on location and/or other attributes in any combination. According to one embodiment, particular offers/awards/prizes are targeted to particular users and locations. For instance, some awards may be only applicable to particular geographic area or may be legal within that area. Further, an operator may target applications with which the offers/awards/prizes may be available at block 1604. According to one embodiment, particular offers/awards/prizes may be only associated with certain applications. At block 1105, the system makes those offers/awards/prizes available to particular applications. At block 1106, process 1100 ends.

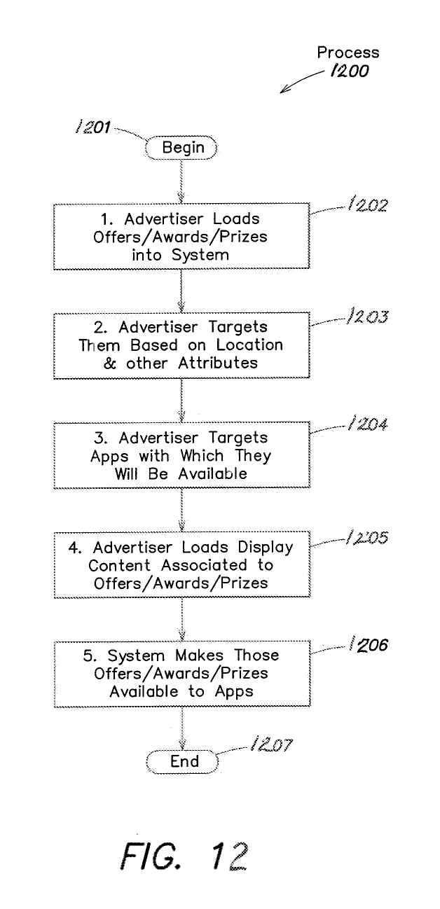

FIG. 12 shows a flowchart for monitoring user behavior according to one embodiment of the present invention. At block 1201, process 1200 begins. A block 1202, the advertiser loads offers/awards/prizes into the system. For instance, this information may be uploaded to the system via an advertiser portal or some other interface. At block 1203, the advertiser targets the offers/awards/prizes based on location and/or other attributes in any combination. At block 1204, an advertiser targets particular applications with which the offers/awards/prizes are available. At block 1205, and advertiser loads display content associated with particular offers/awards/prizes to the system. As discussed above, this may be accomplished using, for instance, a portal provided to the advertiser. At block 1206, the loyalty system makes the loaded offers/awards/prizes available to particular applications. At block 1207, process 1200 ends.

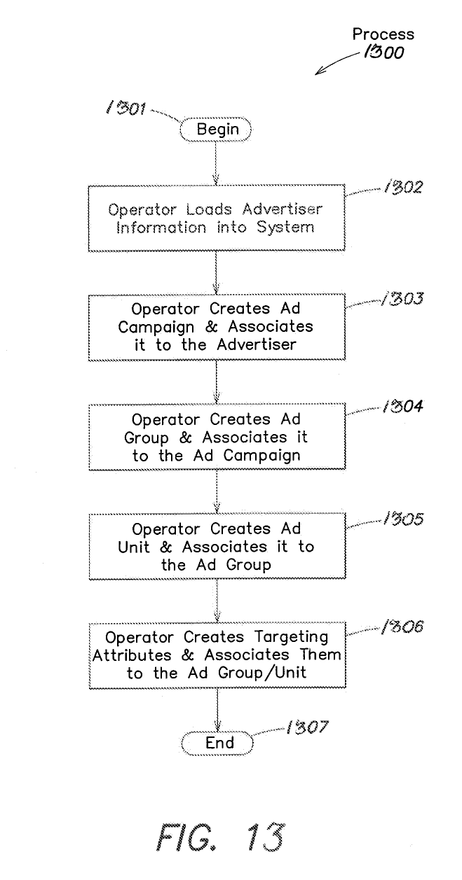

FIG. 13 shows a flowchart for monitoring user behavior according to one embodiment of the present invention. At block 1301, process 1300 begins. At block 1302, and operator loads advertiser information to the loyalty system. At block 1303, an operator creates an ad campaign and associates the campaign to the advertiser. According to one embodiment, interface tools may be provided to an operator (e.g., a user associated with the advertiser) that allow the advertiser to create and manage particular advertising campaigns. At block 1304, the operator creates an ad group and associates the group with the ad campaign. At block 1305, the operator creates an ad unit associates the ad unit to the ad group. At block 1306, the operator creates targeting attributes and associates these attributes to the ad group/unit combination. At block 1307, process 1300 ends.

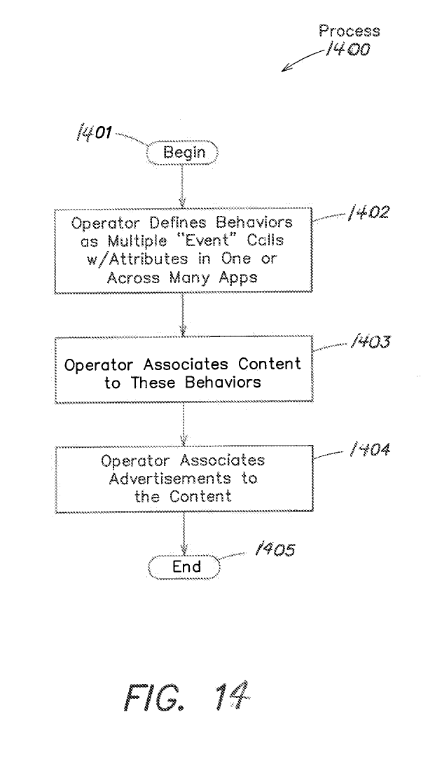

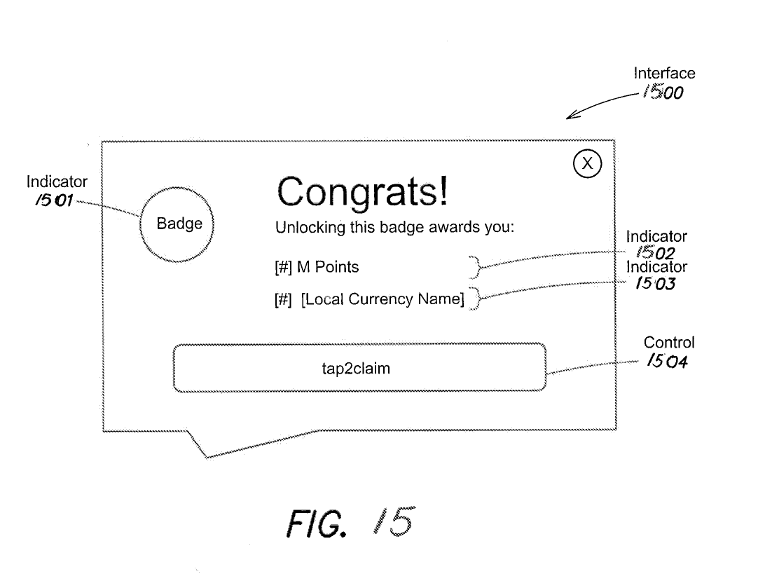

FIG. 14 shows a flowchart for monitoring user behavior according to one embodiment of the present invention. At block 1401, process 1400 begins. At block 1402, an operator defines behaviors as multiple “event” calls with attributes in one application or cross multiple applications. According to one embodiment, behaviors defined in the system may encompass more than one application, allowing easier creation of events among many applications and/or venue location activities. For instance, an application developer may choose to define a behavior that encompasses more than one application provided by the application developer. Further, in another example, an advertiser may want to define an event that spans different applications but yet relates to the same type of activity that the advertising would like to encourage. At block 1403, the operator associates content to these behaviors. Block 1404, the operator associates one or more advertisements to the content. At block 1405, process 1400 ends.

FIG. 15 shows an example user interface according to one embodiment of the present invention. As shown, interface 1500 may include one or more areas (e.g., a pop-up window displayed in the interface of a mobile device) that may be displayed to a user upon the user triggering some event or otherwise exhibiting some behavior. In one embodiment, interface 1500 may indicate some level of status such as an indicator 1501 (e.g., a badge) that the user has achieved by exhibiting the behavior using one or more applications or performing one or more actions at the venue location. Further, the interface may display to the user an amount of loyalty points that the user has accrued over time based on their actions as shown by indicator 1502. Further, according to one embodiment, an advertiser or developer may define some type of local currency that may be awarded to a particular user and that may be indicated by indicator 1503. According to one embodiment, the interface 1500 of the user device may display a control 1504, that when activated, permits the user to claim a particular award that is presented to the user.

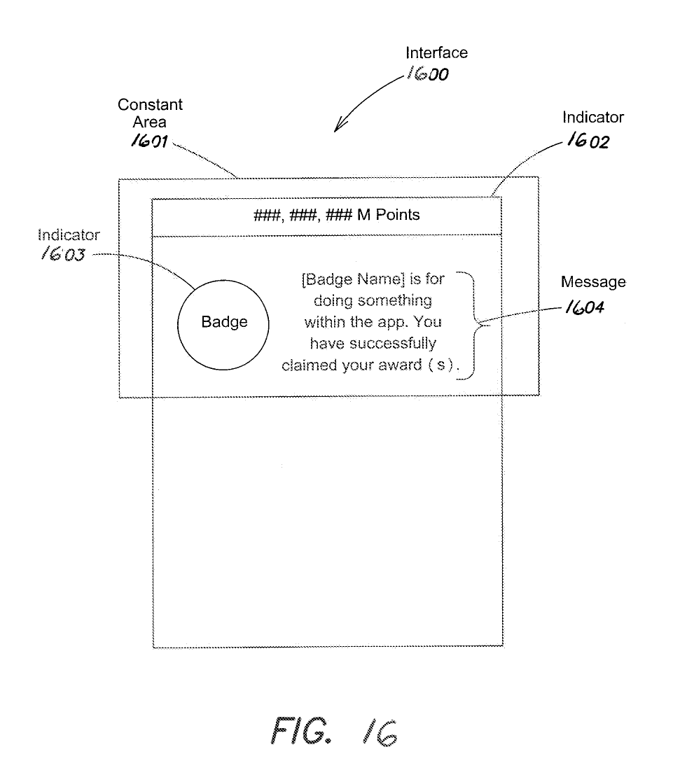

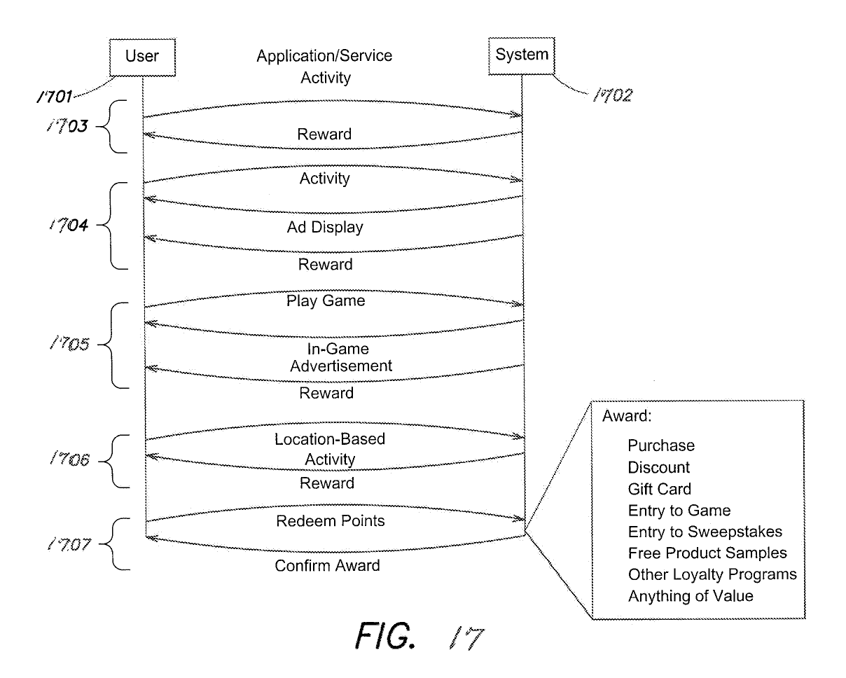

FIG. 16 shows another example user interface according to one embodiment of the present invention. As shown, interface 1600 may include one or more areas (e.g., a pop-up window) that may be displayed to the user upon the user claiming particular award (e.g., by selecting control 1504). Interface 1600 may include a constant area 1601 which includes information in a predefined format and located in a number of fixed areas within the interface. For example, interface 1600 may include an indicator 1603 that provides an indication of some status award (e.g., a badge). A message 1604 may be provided that indicates what status was awarded by performing the action within the application. Further, message 1604 may indicate that the user has successfully claimed the award. Such messages may be standardized to encompass multiple applications, advertisers, and operators.

FIG. 17 shows an example of implementation for monitoring and rewarding user behavior according to one embodiment of the present invention. In particular, FIG. 17 shows a user 1701 interacting with the system 1702 (e.g., a loyalty system) in a number of example transactions. As discussed, user 1701 may operate a mobile device or other computer system type, and the user may interact with one or more applications that are being monitored by system 1702, and/or may perform one or more actions at the venue location. In one example transaction 1703, the user performs some application or service activity which is communicated from the mobile device to system 1702. Responsive to that activity, a reward is communicated to the mobile device operated by the user and an indication of the reward is displayed to the user.

In another example transaction 1704, the user performs some activity within the application, service, and/or venue location and responses to activity and advertisement is transmitted to the mobile device and display to the user. After the user has viewed the advertisement, a reward may be provided to the user and communicated to the mobile device. In another example transaction 1705, a user plays a particular game and while playing that game receives an in-game advertisement. After the advertisement is viewed at the mobile device, a reward is provided to the user.

In another example transaction 1706, the user performs some location—based activity (e.g., the user “checks in” to a particular location within a location-based service (e.g., a location within the venue location)) and receives a reward based on that activity. In another example transaction 1707, a user may be permitted to redeem points the user was awarded based on their application activity. As discussed, awards may include a purchase of products or services, discounts, a gift card, one or more entries to games or sweepstakes, free product samples, points awarded in other loyalty programs, or any other thing of value may be provided to the user. Also, the user may be provided a multiplier bonus that multiplies already-earned points, or otherwise increases an award already provide to the user. The message may require some other action, such as the user selecting a control that initiates a game or sends a message to other users. Further, the confirmation of the award may be communicated to the mobile device and presented to the user within the interface of the mobile device.

The use of the word venue refers to any real, virtual, or fictitious location. For example, the venue can be a real world sports stadium, theatre, or a fan's living room. In another example, the venue can be a location in a virtual game or virtual world. In another example, the venue can be a fictitious location such as a city on the Moon or a historical location like the Roman Coliseum. The use of the word fan is used to refer not only to a fan of a sport or entertainer, but to any user that engages with the system.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases.

What is claimed is:

1. A method operable by a computer system associated with a venue, the method comprising acts of:
identifying, by a computer system, a user uniquely among a plurality of users;
associating, by the computer system, the user with an entry in the venue;
determining a location of the user in relation to the venue; and
performing an action with respect to the user based on the user location in relation to the venue.

2. The method according to claim 1, wherein the entry in the venue includes a ticket, and wherein the method further comprises associating the user with the ticket.

3. The method according to claim 1, wherein the ticket includes a unique identifier and wherein the computer system is operable to perform an act of associating the unique identifier with an identifier of the user.

4. The method according to claim 3, further comprising an act of creating an account for the user, the account including the identifier of the user.

5. The method according to claim 4, further comprising an act of storing, by the computer system, one or more elements associated with the user account including at least one of a group comprising:
a username;
a password;
demographic information;
psychographic information;
an identifier of a computer system associated with the user;
a phone number;
account information;
a mobile identifier; and
a biometric identifier.

6. The method according to claim 1, wherein the act of determining a location of the user in relation to the venue includes acts of scanning, at the venue, a ticket associated with the user, and identifying the user as being located at the venue responsive to the act of scanning.

7. The method according to claim 1, wherein the act of determining a location of the user in relation to the venue includes acts of accepting input from the user, at the venue, an entry identifier associated with the entry into the venue, and identifying the user as being located at the venue responsive to the act of accepting.

8. The method according to claim 1, wherein the act of determining a location of the user in relation to the venue includes acts of determining, by a device associated with the user, the location of the user, and identifying the user as being located at the venue responsive to the act of determining

9. The method according to claim 1, wherein the act of determining a location of the user in relation to the venue includes acts of determining the location of the user, retrieve placement information for the venue, and identifying the user at a particular placement within the venue responsive to the user location and placement information for the venue.

10. The method according to claim 7, further comprising permitting the user to input a ticket identifier associated with the entry into the venue.

11. The method according to claim 7, further comprising permitting the user to take a picture of a ticket associated with the entry into the venue, and deriving information from the picture to determine the location of the user in relation to the venue.

12. The method according to claim 1, wherein the act of determining a location of the user in relation to the venue includes an act of automatically determining the location of the user responsive to actions performed by the user within the venue.

13. The method according to claim 1, further comprising an act of storing purchasing information for the user and associating the purchasing information with the entry.

14. The method according to claim 13, further comprising an act of permitting the user to perform a purchase using information identifying the entry into the venue.

15. The method according to claim 13, wherein the purchase information includes at least one of bank account, credit account, or debit account information associated with the user.

16. The method according to claim 1, wherein the act of performing an action with respect to the user based on the user location in relation to the venue includes permitting the user to receive a promotion responsive to the location in relation to the venue.

17. The method according to claim 1, further comprising acts of determining a location of the user relative to a location of another at the venue and performing an action with respect to the user based on determined relative location.

18. The method according to claim 1, wherein the act of performing an action with respect to the user based on the user location in relation to the venue includes communicating the user location to one or more other users.

19. The method according to claim 1, wherein the act of performing an action with respect to the user based on the user location in relation to the venue includes communicating the user location to one or more other systems.

20. The method according to claim 1, wherein the act of performing an action with respect to the user based on the user location in relation to the venue includes communicating the user location to a social networking system.

21. The method according to claim 20, further comprising an act of permitting the user to send a communication identifying the user location to a network of users associated with the social networking system.

22. The method according to claim 20, further comprising an act of permitting the user to locate other users that are located at the venue and are defined within the social network system.

23. The method according to claim 1, wherein the act of performing an action with respect to the user based on the user location in relation to the venue includes communicating the user location to an entertainment system located within the venue.

24. The method according to claim 1, wherein the act of performing an action with respect to the user based on the user location in relation to the venue includes offering membership to a loyalty program responsive to the user location in relation to the venue.

25. The method according to claim 14, wherein the act of permitting includes permitting the user to purchase, at the venue using the information identifying the entry, at least one of food, drinks, parking, products and services.

26. The method according to claim 14, wherein the act of permitting includes permitting the user to win via a game, earn via an action, or be given via marketing promotion at least one of food, drinks, parking, products, or services.

27. The method according to claim 1, wherein the act of performing an action with respect to the user based on the user location in relation to the venue includes awarding, by a loyalty system, one or more awards to the user.

28. The method according to claim 27, wherein the act of awarding is responsive to a determination that the user has taken an action in relation to the venue.

29. The method according to claim 1, further comprising an act of providing an abstraction layer that communicates information among a plurality of systems and services.

30. The method according to claim 29, further comprising an act of maintaining loyalty information among a plurality of systems and services.

31. A computer system associated with a venue comprising:
a memory;
a processor operatively connected with the memory for executing system components, including:
a component that stores, in the memory information identifying a user uniquely among a plurality of users;
a component that associates the user with an entry in the venue;
a component that determines a location of the user in relation to the venue; and
a component that performs an action with respect to the user based on the user location in relation to the venue.

32. The system according to claim 31, wherein the entry in the venue includes a ticket, and wherein the system further comprises a component that associates the user with the ticket.

33. The system according to claim 32, wherein the ticket includes a unique identifier and wherein the processor is adapted to associate the unique identifier with an identifier of the user.

34. The system according to claim 33, further comprising a component that creates an account for the user, the account including the identifier of the user.

35. The system according to claim 34, wherein the processor is adapted to store, in the memory, one or more elements associated with the user account including at least one of a group comprising:
a username;
a password;
demographic information;
psychographic information;
an identifier of a computer system associated with the user;
a phone number;
account information;
a mobile identifier; and
a biometric identifier.

36. The system according to claim 31, further comprising a scanner operable to scan, at the venue, a ticket associated with the user, and wherein the system includes a component that identifies the user as being located at the venue responsive to the scan of the ticket.

37. The system according to claim 31, further comprising a component that accepts input from the user, at the venue, an entry identifier associated with the entry into the venue, and a component that identifies the user as being located at the venue responsive to the acceptance of input from the user.

38. The system according to claim 31, further comprising a user device that is configured to determine the location of the user, and wherein the system includes a component that identifies the user as being located at the venue responsive to determining the location of the user.

39. The system according to claim 31, further comprising a component that determines the location of the user, retrieve placement information for the venue, and a component that identifies the user at a particular placement within the venue responsive to the user location and placement information for the venue.

40. The system according to claim 37, further comprising a component that permits the user to input a ticket identifier associated with the entry into the venue.

41. The system according to claim 37, further comprising a component that permits the user to take a picture of a ticket associated with the entry into the venue, and a component that derives information from the picture to determine the location of the user in relation to the venue.

42. The system according to claim 31, further comprising a component that automatically determines the location of the user responsive to actions performed by the user within the venue.

43. The system according to claim 31, further comprising a component that stores purchasing information for the user and associating the purchasing information with the entry.

44. The system according to claim 43, further comprising a component that permits the user to perform a purchase using information identifying the entry into the venue.

45. The system according to claim 43, wherein the purchase information includes at least one of bank account, credit account, or debit account information associated with the user.

46. The system according to claim 31, further comprising a component that permits the user to receive a promotion responsive to the location in relation to the venue.

47. The system according to claim 31, further comprising a component for determining a location of the user relative to a location of another at the venue and a component for performing an action with respect to the user based on determined relative location.

48. The system according to claim 31, further comprising a component that communicates the user location to one or more other users.

49. The system according to claim 31, further comprising a component that communicates the user location to one or more other systems.

50. The system according to claim 31, further comprising a component that communicates the user location to a social networking system.

51. The system according to claim 50, further comprising a component that permits the user to send a communication identifying the user location to a network of users associated with the social networking system.

52. The system according to claim 50, further comprising a component that permits the user to locate other users that are located at the venue and are defined within the social network system.

53. The system according to claim 31, further comprising a component that communicates the user location to an entertainment system located within the venue.

54. The system according to claim 31, further comprising a component that offers membership to a loyalty program responsive to the user location in relation to the venue.

55. The system according to claim 31, further comprising a component that permits the user to perform a purchase using information identifying the entry into the venue.

56. The system according to claim 55, wherein the component that permits the user to perform a purchase permits the user to purchase, at the venue using the information identifying the entry, at least one of food, drinks, parking, products and services.

57. The system according to claim 55, wherein the component that permits the user to perform a purchase permits the user to win via a game, earn via an action, or be given via marketing promotion at least one of food, drinks, parking, products, or services.

58. The system according to claim 31, wherein the component that performs an action with respect to the user based on the user location in relation to the venue includes a component adapted to award, by a loyalty system, one or more awards to the user.

59. The system according to claim 58, wherein the component adapted to award is responsive to a component that is adapted to determine that the user has taken an action in relation to the venue.

60. The system according to claim 31, further comprising an abstraction layer component adapted to communicate information among a plurality of systems and services.

61. The system according to claim 60, wherein the abstraction layer component is further adapted to maintain loyalty information among a plurality of systems and services.
